(19) United States
(12) Patent Application Publication
(10) Pub. No.: US 2024/0396157 A1
(43) Pub. Date: Nov. 28, 2024

(54) VENTING DEVICE FOR BATTERY SYSTEM AND BATTERY SYSTEM INCLUDING THE SAME

(71) Applicant: HYUNDAI MOBIS CO., LTD., Seoul (KR)

(72) Inventor: Yoo Jeong LEE, Seoul (KR)

(73) Assignee: HYUNDAI MOBIS CO., LTD., Seoul (KR)

(21) Appl. No.: 18/599,869

(22) Filed: Mar. 8, 2024

(30) Foreign Application Priority Data
May 24, 2023 (KR) 10-2023-0066728

(51) Int. Cl. H01M 50/342; H01M 10/48; H01M 50/375; H05B 3/16

(52) U.S. Cl. CPC H01M 50/3425; H01M 10/48; H01M 50/375; H05B 3/16; H05B 2203/004

(57) ABSTRACT

A venting device for a battery system includes a venting part disposed on one surface of a case accommodating at least one battery cell and selectively forming a through-hole in the case, a gas sensor disposed inside or on one surface of the case and detecting at least one type of gas, and a temperature varying part varying a temperature of the venting part, wherein the venting part includes a melting member melted at a predetermined temperature or higher to form the through-hole.

### CROSS-REFERENCE TO RELATED APPLICATIONS

This application claims priority under 35 U.S.C. § 119 to Korean Patent Application No. 10-2023-0066728, filed on May 24, 2023, in the Korean Intellectual Property Office, the disclosure of which is incorporated herein by reference in its entirety.

### TECHNICAL FIELD

The following disclosure relates to a venting device for a battery system and a battery system including the same, and in particular, to a venting device for a battery system using a melting member and a battery system including the same.

### BACKGROUND

Demand for secondary batteries has rapidly increased in industry fields, such as portable electronic equipment, electric vehicles, and energy storage systems. In addition, demand for performance improvement has increased.

Meanwhile, a typical accident of lithium-ion batteries, which are representative of secondary batteries, is thermal runaway, which refers to a chain reaction of heat generation due to electrochemical side reactions caused by substances present inside batteries. As a result, smoke, flames, and explosions may cause accidents and casualties in systems equipped with secondary batteries.

In the related art, various venting methods have been disclosed that may minimize damage caused by thermal runaway of batteries as described above. FIG. 1 shows a rupture-type venting method, which may rupture and release gas when internal pressure of a battery system reaches a set pressure. FIG. 2 shows a venting method through a membrane filter. This method may release gas without inflow and outflow of foreign substances through a filter 10, and gas may be released using a pressure difference generated inside a battery system. In addition, FIG. 3 shows a venting method using an internal pressure rise. This method utilizes movement of a structure by using an internal pressure rise of a battery system. As shown in FIG. 3, there are various methods, such as a method of lifting a leaf spring by the internal pressure rise, etc. FIG. 4 shows a venting method using a temperature rise, in which a fusible alloy melts and releases gas when an internal temperature of a battery system rises.

The various conventional methods described above discharge gas from the inside of the battery system by using a pressure difference between the inside and outside of the battery system or discharge gas during thermal runaway by using a thermal plug that melts at a specific temperature when the internal temperature rises. However, this method is a passive method that delays gas discharge at the beginning of thermal runaway because gas is discharged after the internal pressure and temperature of the battery system rise above a certain level.

### SUMMARY

An exemplary embodiment of the present disclosure is directed to providing a venting device for a battery system and a battery system including the same capable of actively discharging gas regardless of an internal temperature and pressure rise of a battery system.

In one general aspect, a venting device for a battery system may include: a venting part disposed on one surface of a case accommodating at least one battery cell and selectively forming a through-hole in the case, a gas sensor disposed inside or on one surface of the case and detecting at least one type of gas and a temperature varying part varying a temperature of the venting part, wherein the venting part includes a melting member melted at a predetermined temperature or higher to form the through-hole.

The venting device further includes: a controller controlling the temperature varying part based on gas detection information received from the gas sensor.

The controller includes a circuit unit that supplies power to the temperature varying part based on the gas detection information.

The temperature varying part includes at least one heating wire disposed between the case and the venting part.

The heating wire is formed in a shape of a circle having a predetermined diameter, and the melting member has a circle shape having a diameter greater than or equal to the diameter of the circle formed by the heating wire.

The heating wire includes a zigzag shape in a predetermined area, and the melting member has a rectangular shape having a width greater than or equal to the area formed by the heating wire.

The heating wire includes a nichrome wire.

The melting member includes an elastomer.

A battery system comprising: the venting device having the aforementioned characteristics and the case accommodating a plurality of battery cells.

### BRIEF DESCRIPTION OF THE DRAWINGS

FIG. 1 is a diagram illustrating a rupture-type venting method of the related art;

FIG. 2 is a diagram illustrating a venting method using a membrane filter of the related art;

FIG. 3 is a diagram illustrating a venting method using an internal pressure rise of the related art;

FIG. 4 is a diagram illustrating a venting method using a temperature rise of the related art;

FIG. 5 is a perspective view illustrating a battery system including a venting device according to an exemplary embodiment of the present disclosure;

FIG. 6 is an enlarged view illustrating a venting device of the battery system of FIG. 5;

FIG. 7 is a perspective view illustrating a battery system including a venting device according to another exemplary embodiment of the present disclosure; and

FIG. 8 is an enlarged view illustrating the venting device of the battery system of FIG. 7.

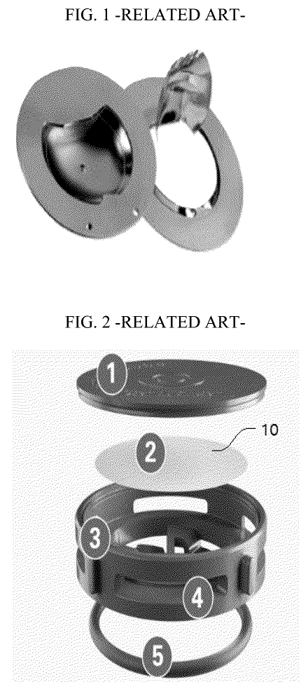

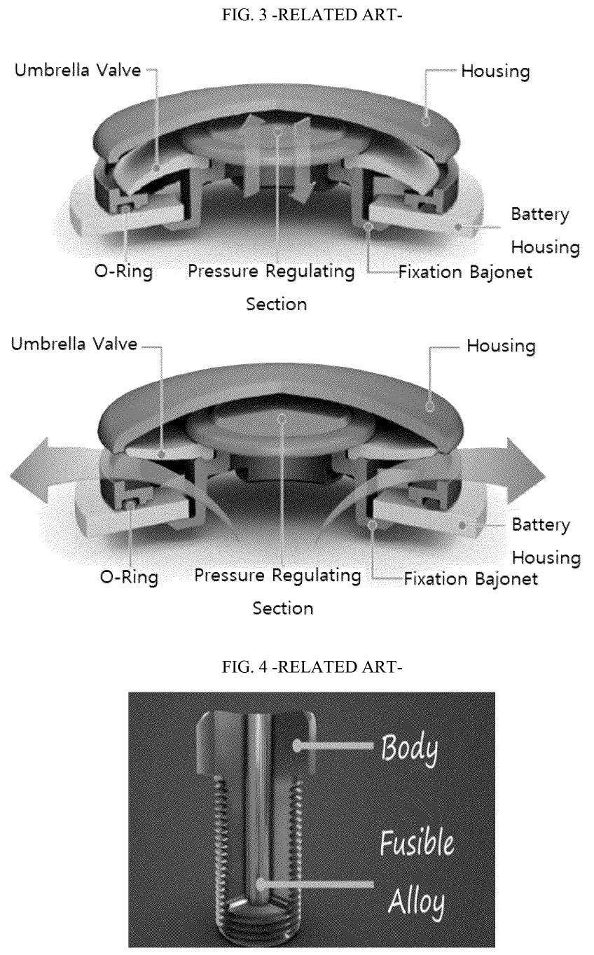

### DETAILED DESCRIPTION OF EXEMPLARY EMBODIMENTS

In order to describe the present disclosure, the operational advantages of the present disclosure, and the objects achieved by the practice of the present disclosure, exemplary embodiments of the present disclosure are described.

Terms used in the present application are used only to describe specific exemplary embodiments, and are not intended to limit the present disclosure. A singular form may include a plural form if there is no clearly opposite meaning in the context. It will be further understood that the terms “comprises” or “have” used in this specification specify the presence of stated features, numerals, components, parts, or a combination thereof, but do not preclude the presence or addition of one or more other features, numerals, components, parts, or a combination thereof.

In describing the present disclosure, if it is determined that a detailed description of a related known configuration or function may obscure the gist of the present disclosure, the detailed description will be omitted.

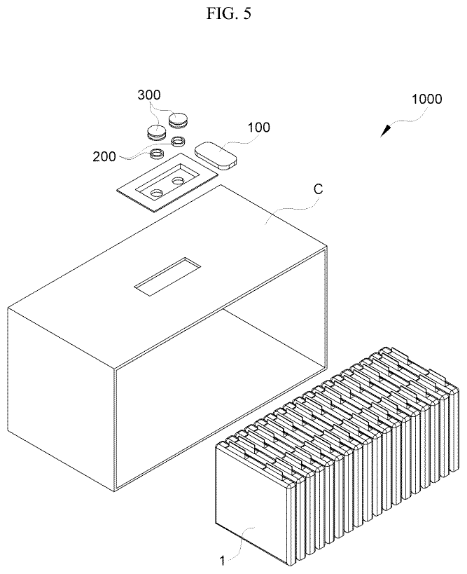

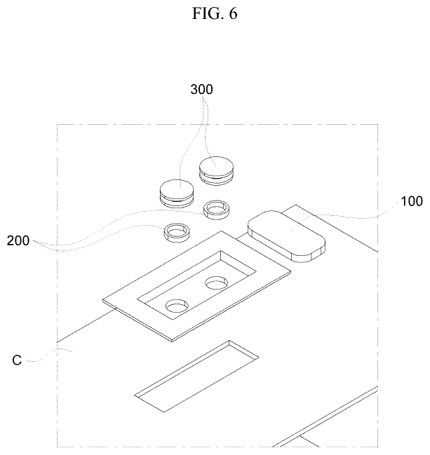

FIG. 5 is a perspective view illustrating a battery system including a venting device according to an exemplary embodiment of the present disclosure, and FIG. 6 is an enlarged view illustrating the venting device of the battery system of FIG. 5.

Hereinafter, a venting device for a battery system according to an exemplary embodiment of the present disclosure will be described with reference to FIGS. 5 and 6.

A venting device of a battery system 1000 according to an exemplary embodiment of the present disclosure may include a venting part, a gas sensor 100, and a temperature varying part.

The venting part may be provided on one surface of a case C that accommodates at least one battery cell 1. In addition, a through-hole may be selectively formed in the case C.

The gas sensor 100 may be provided inside or on one surface of the case C, and may detect at least one type of gas.

The temperature varying part may vary a temperature of the venting part.

At this time, the venting part may include a melting member 300, and the melting member 300 may be melted at a predetermined temperature or higher to form a through-hole.

Specifically, the temperature varying part may include at least one heating wire 200, and the heating wire 200 may be provided between the case C and the venting part, i.e., between the case C and the melting member 300.

More specifically, the heating wire 200 may be provided between the case C and the melting member 300, and when gas is detected by the gas sensor 100, a predetermined current may flow according to application of external power.

Thereafter, due to heat generated by the current, the melting member 300 may be melted, thereby generating a through-hole.

In addition, the venting device of the battery system 1000 according to another exemplary embodiment of the present disclosure may further include a controller (not shown).

The controller may control the temperature varying part based on gas detection information, which is information on whether gas is detected, received from the gas sensor 100.

Specifically, the controller may include a circuit unit (not shown) that supplies power to the temperature varying part, etc. based on the gas detection information.

More specifically, the circuit unit may include a relay for supplying power to the temperature varying part.

In addition, when the temperature varying part is the heating wire 200, as described above, a predetermined current may flow through the heating wire 200 in accordance with the application of power by the controller, and heat may be generated to melt the melting member 300.

Here, the number or an installation location of the heating wire 200 and the melting member 300 provided in the case C is not limited thereto, and may vary depending on a size or capacity of the plurality of battery cells 1.

Specifically, as shown in FIG. 6, the venting device of the battery system according to the present disclosure may be installed in an upper portion of the case C and discharge gas generated by the plurality of battery cells 1 provided inside the case C rapidly to the outside.

To this end, more specifically, the heating wire 200 may be formed in a circular shape having a predetermined diameter.

At this time, a plurality of the circular heating wires 200 may be provided at predetermined intervals.

In addition, the melting member 300 may be circular with a diameter greater than or equal to a circular diameter formed by the heating wire 200.

In addition, the melting member 300 may be provided at the top of the heating wire 200 and may be melted by heat generation of the heating wire 200 to form a hole.

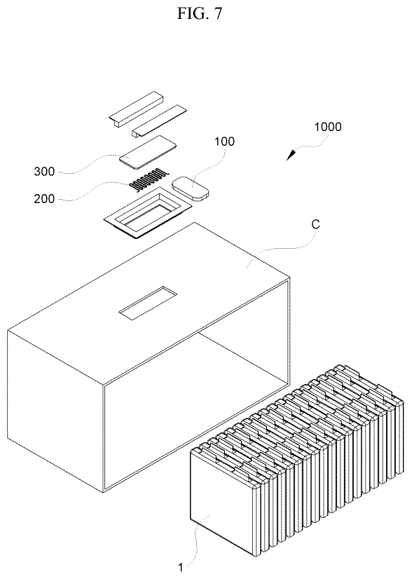

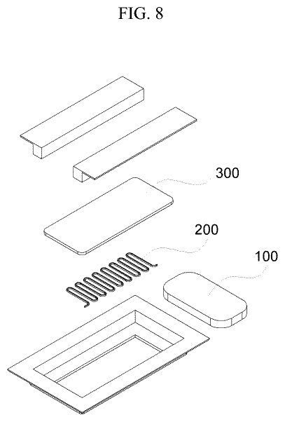

FIG. 7 is a perspective view illustrating a battery system including a venting device according to another exemplary embodiment of the present disclosure, and FIG. 8 is an enlarged view illustrating the venting device of the battery system of FIG. 7.

Specifically, as shown in FIG. 7, the venting device of the battery system 1000 according to the present disclosure is installed on an upper portion of the case C to rapidly discharge gas generated in a plurality of battery 1 provided inside the case C to the outside.

Here, the number or an installation location of the heating wire 200 and the melting member 300 provided in the case C is not limited thereto and may vary depending on the size or capacity of the plurality of battery cells 1.

More specifically, as shown in FIG. 8, the heating wire 200 may be bent a predetermined number of times to have a zigzag shape in a predetermined area.

In addition, the melting member 300 may be a rectangle having a width greater than or equal to an area formed by the heating wire 200.

In addition, the melting member 300 may be provided at the top of the heating wire 200 and may be melted by heat generation of the heating wire 200 to form a hole.

At this time, referring to the shape of the melting member 300, the size of the hole may be larger in the case of the rectangular shape shown in FIG. 8 than the circular shape shown in FIG. 6.

Accordingly, a large amount of gas may be discharged more rapidly.

In various exemplary embodiments of the present disclosure, the shape of the melting member 300 is limited to the circle or square as shown in FIGS. 6 and 8, but this is only an exemplary embodiment, and the shape may vary as needed.

Meanwhile, a thermal runaway gas generated by the battery cell 1 is typically hydrogen gas.

Accordingly, the heating wire 200 is preferably formed of a material that may withstand high temperatures and has such high resistivity as to generate heat by current.

Specifically, the heating wire 200 is preferably a nichrome wire that has high resistance and may quickly generate heat according to flow of current.

In the present exemplary embodiments, the heating wire 200 is described as being a nichrome wire, but the type of heating wire 200 is not limited thereto as long as it is formed of a material that may quickly generate heat according to flow of current.

In addition, the melting member 300 may include an elastomer, which is a polymer compound with good elasticity, such as rubber.

Specifically, the melting member 300 is preferably formed of fluorine silicone rubber that may block oil or contaminants and has excellent sealing performance.

Hereinafter, the operation of the venting device of the battery system including the components described above will be described again.

First, the gas sensor 100 may detect thermal runaway gas caused by the plurality of battery cells 1.

Thereafter, the gas detection information may be transmitted to the controller.

At this time, the controller may be included in the battery system of the present disclosure or may be an external CMU (computer).

The controller may generate current according to application of power to the heating element 200 in response to the received gas detection information.

Accordingly, current may flow through the heating wire 200, and the heating wire 200 may generate heat.

As a result, the melting member 300 located in an upper portion of the heating wire 200 is melted, thereby forming a through-hole through which the thermal runaway gas may be discharged.

The venting device for a battery system according to various exemplary embodiments of the present disclosure is structurally simpler than a solenoid valve, which is an electromagnetic valve of the related art and may thus reduce weight.

In addition, by varying the shape of the melting member 300, the shape of the through-hole may be freely implemented.

In addition, since gas is detected by the gas sensor 100, thermal runaway gas may be discharged at the beginning of thermal runaway, thereby preventing the spread of flames and gas to prevent thermal runaway between the battery cells, and the gas may be actively vented regardless of a pressure and temperature rise in the battery system 1000.

Meanwhile, the battery system 1000 according to another exemplary embodiment of the present disclosure may include the venting device and case C of the battery system 1000 as described above.

The venting device of the battery system 1000 is the same as that described above and will therefore be omitted.

The case C may accommodate a plurality of battery cells 1, and the venting device of the battery system 1000 may be provided on one surface of the case C.

As a result, thermal runaway gas generated by the plurality of battery cells 1 may be discharged through the venting device of the battery system 1000.

According to the venting device for a battery system and the battery system including the same according to various exemplary embodiments of the present disclosure as described above, gas may be discharged at the beginning of thermal runaway, thereby preventing the spread of flames and gas to prevent thermal runaway between the battery cells.

In addition, gas may be vented regardless of pressure and temperature rise within the battery system.

Although the preferred exemplary embodiments of the present disclosure have been described above, the exemplary embodiments disclosed in the present disclosure are not intended to limit the technical spirit of the present disclosure, but are only for explanation. Therefore, the technical spirit of the present disclosure includes not only each disclosed exemplary embodiment, but also a combination of the disclosed exemplary embodiments, and furthermore, the scope of the technical spirit of the present disclosure is not limited by these exemplary embodiments. In addition, those skilled in the art to which the present disclosure pertains may make many changes and modifications to the present disclosure without departing from the spirit and scope of the appended claims, and all such appropriate changes and modifications, as equivalents, are to be regarded as falling within the scope of the present disclosure.

### DETAILED DESCRIPTION OF MAIN ELEMENTS

C: case
1: battery cell
10: filter
1000: battery system
100: gas sensor
200: heating wire
300: melting member

What is claimed is:

1. A venting device for a battery system, the venting device comprising:
a venting part disposed on one surface of a case accommodating at least one battery cell and selectively forming a through-hole in the case;
a gas sensor disposed inside or on one surface of the case and detecting at least one type of gas; and
a temperature varying part varying a temperature of the venting part,
wherein the venting part includes a melting member melted at a predetermined temperature or higher to form the through-hole.

2. The venting device of claim 1, further comprising:
a controller controlling the temperature varying part based on gas detection information received from the gas sensor.

3. The venting device of claim 2, wherein the controller includes a circuit unit that supplies power to the temperature varying part based on the gas detection information.

4. The venting device of claim 1, wherein the temperature varying part includes at least one heating wire disposed between the case and the venting part.

5. The venting device of claim 4, wherein
the at least one heating wire is formed in a shape of a circle having a predetermined diameter, and
the melting member has a circular shape having a diameter greater than or equal to the predetermined diameter of the circle formed by the at least one heating wire.

6. The venting device of claim 4, wherein
the at least one heating wire includes a zigzag shape in a predetermined area, and
the melting member has a rectangular shape having a width greater than or equal to the predetermined area formed by the at least one heating wire.

7. The venting device of claim 4, wherein the at least one heating wire includes a nichrome wire.

8. The venting device of claim 1, wherein the melting member includes an elastomer.

9. A battery system comprising:
the venting device of claim 1; and
the case accommodating of the at least one battery cell.
